(19) United States
(12) Patent Application Publication
(10) Pub. No.: US 2013/0291361 A1
(43) Pub. Date: Nov. 7, 2013

(54) MODULAR KEY SYSTEM

(71) Applicant: AVITAL FRUMKIN, Raanana (IL)

(72) Inventor: AVITAL FRUMKIN, Raanana (IL)

(21) Appl. No.: 13/802,814

(22) Filed: Mar. 14, 2013

Related U.S. Application Data
(60) Provisional application No. 61/612,415, filed on Mar. 19, 2012.

(51) Int. Cl. E05B 19/00

(52) U.S. Cl. CPC E05B 19/00
USPC 29/428; 29/700

(57) ABSTRACT

The subject matter discloses a key generator, the key generator comprising a key cylinder; wherein the key cylinder comprises a bay, wherein the bay being adapted for accommodating a metal element; wherein the metal element a having a plurality of gullies; thereby providing a key formation by rotating the cylinder for finding a gulley from said plurality of gullies wherein said gully having a desired depth, wherein said key generator being adapted for fitting a pin piece into holes of said metal element thereby, coupling pieces of said metal element in a key array.

### FIELD OF THE INVENTION

The present disclosure relates to keys in general, and to generating keys, in particular.

### BACKGROUND

A key is an instrument that is used to operate a lock. A typical key is a small piece of metal consisting of two parts: the blade, which slides into the key way of the lock and distinguishes between different keys, and the bow, which is left protruding so that torque can be applied by the user. A key is usually intended to operate one specific lock or a small number of locks that are keyed alike, so each lock requires a unique key. The key serves as a security token for access to the locked area; only persons having the correct key can open the lock and gain access.

A master key operates a set of several locks. Usually, there is nothing special about the key itself, but rather the locks into which it will fit. These master-keyed locks are designed to open with two different keys; one which is specific to each lock and cannot operate any of the others in the set, and the master key, which opens all the locks in the set. Locks that have master keys have a second set of the mechanism used to operate them that is identical to all of the others in the set of locks. For example, master keyed pin tumbler locks will have two shear points at each pin position, one for the change key and one for the master key. A far more secure (and more expensive) system has two cylinders in each lock, one for the change key and one for the master key.

Key blanks (sometimes spelled keyblank) are keys that have not been cut to a specific bitting (a bitting is the part of the key that actually engages the tumblers to activate the lock). The blank has a specific cross-sectional profile to match the keyway in a corresponding lock cylinder. Key blanks can be stamped with a manufacturer name, end-user logo or with a phrase, the most commonly seen being ‘Do not duplicate’. Blanks are typically stocked by locksmiths for duplicating keys.

### BRIEF SUMMARY

One exemplary embodiment of the disclosed subject matter is a key generator, the key generator comprising a key cylinder; wherein the key cylinder comprises a bay, wherein the bay being adapted for accommodating a metal element; wherein the metal element a having a plurality of gullies; thereby providing a key formation by rotating the cylinder for finding a gulley from said plurality of gullies wherein the gully having a desired depth, wherein the key generator being adapted for fitting a pin piece into holes of said metal element thereby, coupling pieces of said metal element in a key array.

One other exemplary embodiment of the disclosed subject matter is a method for manufacturing a key, the method comprising key generator, the key generator comprising a key cylinder; wherein the key cylinder comprises a bay, wherein the bay being adapted for accommodating a metal element; wherein the metal element a having a plurality of gullies; rotating the cylinder for finding a gulley from the plurality of gullies wherein the gully having a desired depth; fitting a pin piece into holes of said metal element thereby, coupling pieces of the metal element in a key array.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 depicts a key element, in accordance with some exemplary embodiments of the subject matter;

FIG. 2 depicts a cylinder, in accordance with some exemplary embodiments of the disclosed subject matter;

FIG. 3 depicts a cylinder accommodating a key element, in accordance with some exemplary embodiments of the disclosed subject matter;

FIG. 4 depicts a central axle in the form of a cylinder, in accordance with some exemplary embodiments of the disclosed subject matter;

FIG. 5 depicts cylinders lined up, in accordance with some exemplary embodiments of the disclosed subject matter;

FIG. 6 depicts an elongated U-shaped double pronged pin piece, in accordance with some exemplary embodiments of the disclosed subject matter;

FIG. 7 depicts a key array; in accordance with some exemplary embodiments of the disclosed subject matter;

FIGS. 8a-b depict, respectively, the back and front pieces of the cylinder with the pin piece, in accordance with some exemplary embodiments of the disclosed subject matter;

FIG. 9 depicts the removal of the selected cylinder pieces coupled together on the pin; in accordance with some exemplary embodiments of the disclosed subject matter;

FIG. 10 depicts a key handle; in accordance with some exemplary embodiments of the disclosed subject matter; and

FIG. 11 depicts completed modular key; in accordance with some exemplary embodiments of the disclosed subject matter.

### DETAILED DESCRIPTION

A key system for generating a master key or any other key according to a code is provided. Alternatively or additionally, the system can be used to create replicate keys or even replacement keys according to code.

One technical problem dealt with by the present disclosure is the needing of all the locks in the group to be changed to those that can be opened by the master key.

One other technical problem is the reduced security due to the nature of the locks that can be opened by a master key.

One other technical problem is the expensive key cutting machinery of the key blanks which are used for replicate keys.

One technical solution is a modular key system which enables any person to generate a key according to a code. Additionally the modular key system enables to recycle a key and to generate a new key from the recycled key. Such a solution is relatively cheap, can be handled by a non professional person and can be readily adapted to a number of key types.

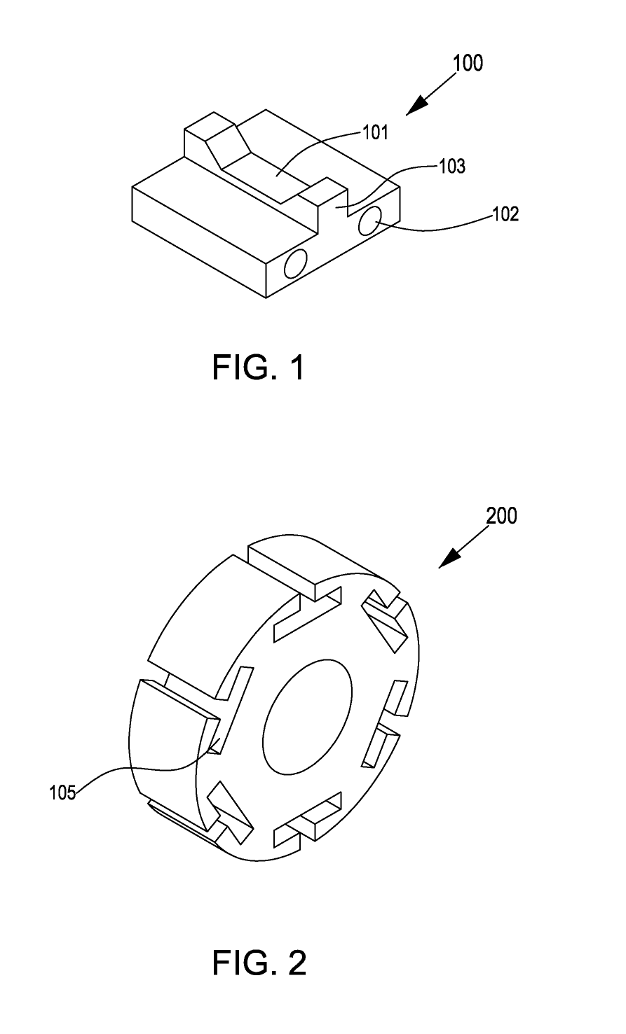

An overview of a current embodiment of the invention presents a modular key. In some embodiments the key has a diameter of 20 mm and a length on 80 mm. The modular system has basic metal element 100 shown in FIG. 1. The element 100 may be substantially 4 mm in length and 4 mm in width with a height of substantially less than 1.5 mm at the peaks of bar 103. The thickness of the central bar 103 may be 2 mm. Depression or gulley 101, situated between the peaks, varies in depth from element to element. The depth of the gulley 101 is parallel to the gulley or valley (or bit) of a regular key. Two parallel holes 102, having an approximate diameter of 1 mm each are found on the base of element 100.

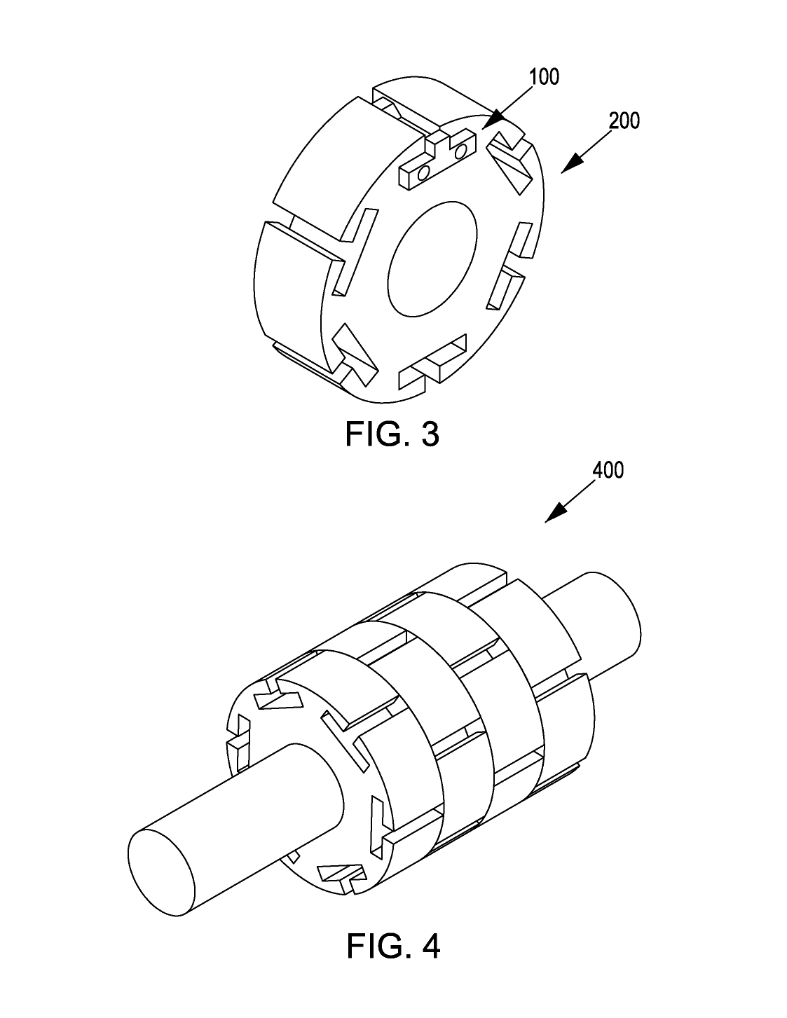

In the depicted cylinder 200 of FIG. 2, there are six bays 105, each one adapted to accommodate or house a single metal element 100 (as seen in FIG. 3). The cylinder 200 is made from any material such as metal, plastic etc. The cylinder 200 may have a diameter of approximately 20 mm and a thickness of substantially 4 mm (which is equal to the length of the basic metal element of FIG. 1). In the depicted embodiment, the cylinder 200 contains six bays 105 or housings for the metal elements, although different embodiments of the cylinders can include more than or less than six bays, therefore the number of bays per cylinder as depicted in the figure is in no way limiting or definitive. Each metal element fitted in the bays has a gulley 101 with a unique depth, so that the cylinder 200 can hold six elements 100 each with a different gulley depth. In the depicted embodiment, it would be logical for the depth of each gulley 101 to differ from the depth of its neighbor by ⅙ of the height from the bottom of the gulley to the level of the peaks. For a cylinder with ten bays, the depth of the gulley of each element would differ from that of its neighbor by approximately 1/10. The system may come with standardized depths for each gulley that may or may not conform to the aforementioned ratio scheme.

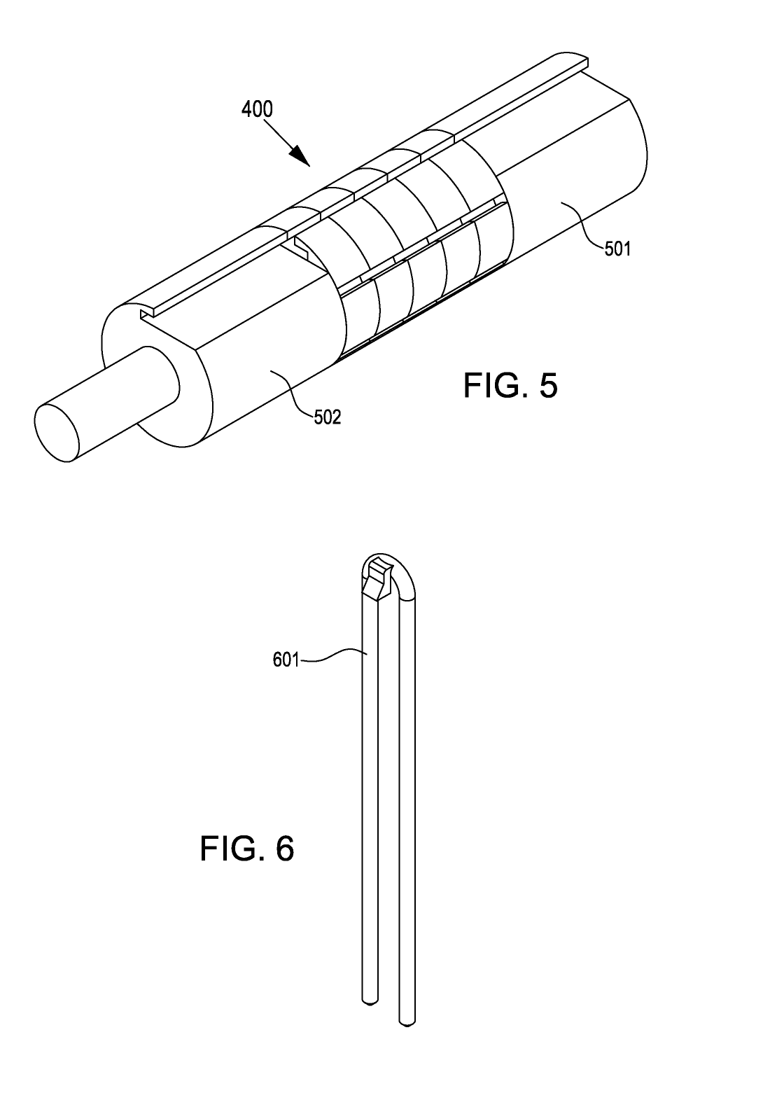

FIG. 4 depicts a central axle 400 in the form of a screw or other elongated cylindrical member, having a threaded surface. Potentially the cylinders may be rotated incrementally with an audible and/or tactile feedback. In the FIG. 5 cylinders 200 are threaded on axle 400. The desired key formation is achieved by rotating each of the cylinders 200 until the desired gulley depth is found for each segment of the key (in the depicted embodiment, the key has five segments with five gullies of different depths).

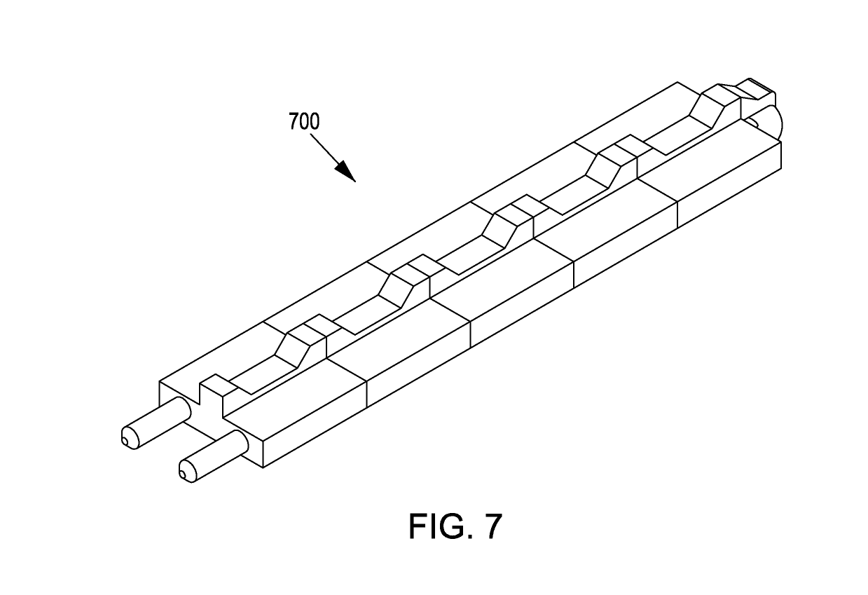

In FIG. 5, the cylinders are lined up according to the method previously described. A front piece 501 is added at one end of the axle 400 and a back, tray piece, 502 is assembled onto the other end of axle 400. Tray piece 502 is approximately the length of the five cylinders combined (i.e. 4 mm×5=20 mm), having a flat section carved out of the cylindrical body. An elongated U-shaped double pronged pin piece 601 is depicted in FIG. 6. The pin piece 601 is adapted to fit into holes 102 of each metal element 104, coupling the pieces together in a key array 700, as can be best seen in FIG. 7. Such pieces can be decoupled for being used for generating a new key.

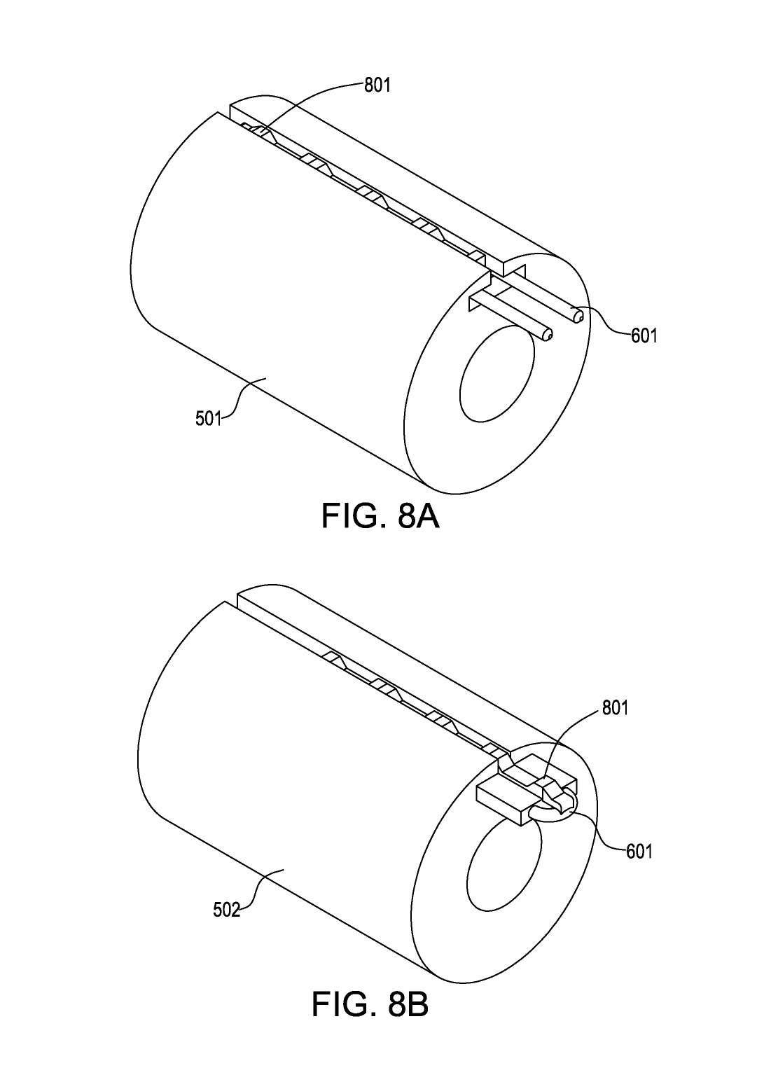

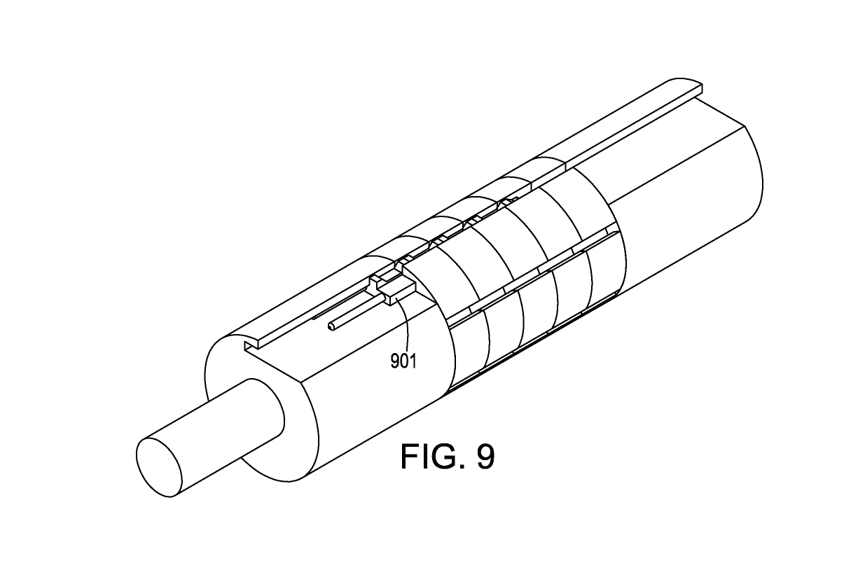

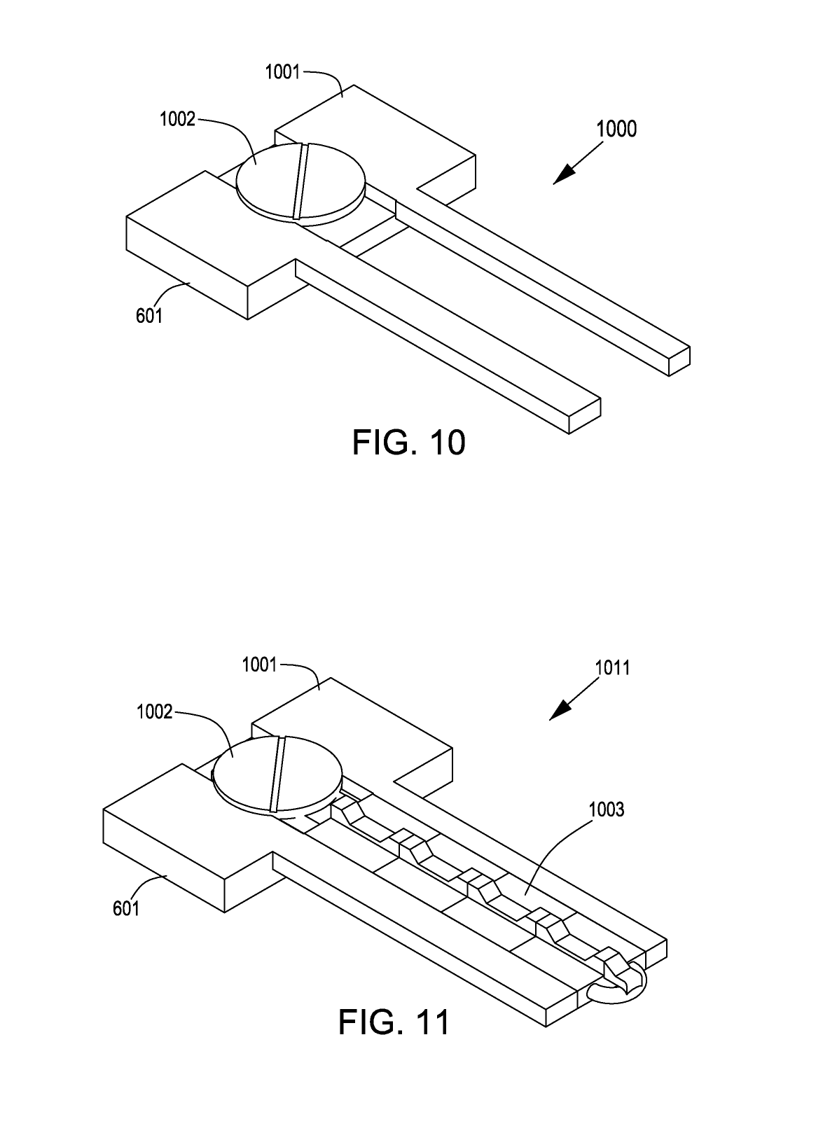

FIGS. 8a-b depict only the front and back pieces (502 and 501) of the cylinder with pin piece 601, respectively, entering front piece 502 and exiting back piece 501. Pin 601 is slid along the path/tunnel of the end pieces and the cylinders with the help of knob 601. FIG. 9 depicts the removal of the selected cylinder pieces coupled together on pin 601 in the direction of the arrow, onto the flat segment 901 of tray piece 501. The next component of the modular key is the key handle or tab 1000 which is depicted in FIG. 10. The tab has a clasp 1002 which is adapted to receive and secure the two prongs of pin 601. Support bar 1001 can be reversibly coupled to tab 1000 on the left or right of the key array, depending on which direction the key needs to turn. Support bar 1001 gives supporting leverage to help rotate the cylinder of a given lock.

The completed modular key 1011 of the current embodiment of the system can be seen in FIG. 11. The key array 1003 serves as the bow of the key or key shaft, and the support bar 1001 assists the user in rotating the cylinder of the lock. A quick swap mechanism allows the user to detach the support bar from one side of the key array and reattach it on the other side.

Various variations and modification of the cylinders, bays, metal elements, axles, supports bars etc. that would clear to one skilled in the art are considered to be included in the scope of the invention, even if not mentioned specifically herein.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A key generator, said key generator comprising a key cylinder; wherein the key cylinder comprises a bay, wherein said bay being adapted for accommodating a metal element; wherein said metal element a having a plurality of gullies; thereby providing a key formation by rotating said cylinder for finding a gulley from said plurality of gullies wherein said gully having a desired depth, wherein said key generator being adapted for fitting a pin piece into holes of said metal element thereby, coupling pieces of said metal element in a key array.

2. A method for manufacturing a key, said method comprising key generator, said key generator comprising a key cylinder; wherein the key cylinder comprises a bay, wherein said bay being adapted for accommodating a metal element; wherein said metal element a having a plurality of gullies;
rotating said cylinder for finding a gulley from said plurality of gullies wherein said gully having a desired depth;
fitting a pin piece into holes of said metal element thereby, coupling pieces of said metal element in a key array.
